(19) United States
(12) Patent Application Publication
(10) Pub. No.: US 2024/0207974 A1
(43) Pub. Date: Jun. 27, 2024

(54) Beam Shaper Optic For Laser Material Processing

(71) Applicant: PowerPhotonic Ltd., Dalgety Bay (GB)

(72) Inventors: Eoin Murphy, Dalgety Bay (GB); Gilles Diederich, Dalgety Bay (GB); Natalia Trela-McDonald, Dalgety Bay (GB); Roy McBride, Dalgety Bay (GB)

(21) Appl. No.: 18/288,136

(22) PCT Filed: May 3, 2022
(86) PCT No.: PCT/EP2022/061852

§ 371 Date: Oct. 24, 2023

(30) Foreign Application Priority Data
May 4, 2021 (GB) 2106338.3
Dec. 21, 2021 (GB) 2118634.1

(51) Int. Cl. B23K 26/073; G02B 27/09

(52) U.S. Cl. CPC B23K 26/0734; G02B 27/0927; G02B 27/095

(57) ABSTRACT

An optical beam shaping element to perform beam shaping of multi-mode laser beams where a uniform ring-shaped intensity distribution is produced at a focal length of a focusing lens. The optical beam shaping element with a surface having radial arms which are twisted to be curved in comparison to a known Siemens star beam shaper giving a spiral configuration. Embodiments are described in which each of the arms in the spiral structure is additionally modified with radially varied slope and/or curvature to optimise far field distribution. Relative rotation between two optical beam shaping elements forms an adjustable trident to vary power between the ring and a centre spot. The optical beam shaping element finds application in laser material processing were the spiral curvature removes hotspots and can be configured to improve through focus performance and input sensitivity.

This invention relates to optical beam shapers for laser material processing applications. In particular, the invention relates to an optical beam shaping element in which a Siemens star beam shaper optic form is twisted around its centre to create a spiral or swirl arrangement. The optical beam shaping element converts the laser intensity distribution into a ring distribution with uniform intensity around the annulus at and around the focal plane of a focusing lens.

A laser beam having a ring-shaped intensity profile is often required in laser material processes such as welding, cutting, the material ablation of thin films, solar cell manufacturing, PCB laser drilling and ophthalmology. Beam shapers such as classic axicons, conical lenses and rotation-symmetrical prisms are often used to generate a ring-like intensity distribution at a focal plane of a focusing lens.

U.S. Pat. No. 4,275,288 discloses a glass cone or axicon which converts the gaussian energy distribution of the laser beam to the energy distribution of the radiation impinging onto the workpiece to be annular in cross-section. These single axicons are sensitive to alignment and to input intensity distribution.

U.S. Ser. No. 10/620,444 discloses a diffractive optical beam shaping element for imposing a phase distribution on a laser beam that is intended for laser processing of a material includes a phase mask that is shaped as an area and is configured for imposing a plurality of beam shaping phase distributions on the laser beam incident on to the phase mask. A virtual optical image is attributed to at least one of the plurality of beam shaping phase distributions, wherein the virtual image can be imaged into an elongated focus zone for creating a modification in the material to be processed. Multiple such elongated focus zones can spatially add up and interfere with each other, to modify an intensity distribution in the material and, for example, generate an asymmetric modification zone. These diffractive optics suffer from poor transmission efficiency, typically 75-95% and are wavelength dependent.

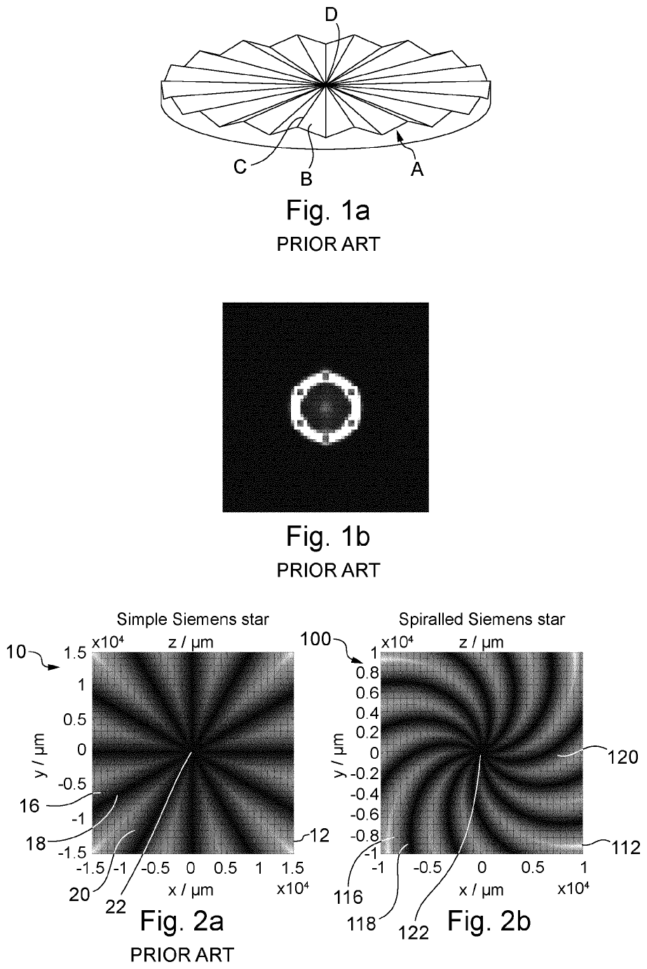

U.S. Ser. No. 10/444,521 discloses a device for machining material by means of laser radiation, including a focusing optics for focusing a laser beam onto a workpiece and an adjusting optics for adjusting the intensity distribution comprising at least two plate-shaped optical elements which are arranged one behind the other in the beam path of the laser beam, which are rotatable relative to one another in the circumferential direction, and which each have a surface with a circular pattern of sector-shaped facets which, in the circumferential direction, are alternately inclined with respect to the respective plate plane. Each plate-shaped optical element can be considered as a Siemens star beam shaper due to the circular pattern of sector-shaped facets in accordance with the known Siemens star for testing imaging qualities. FIG. 1(a) illustrates a Siemens star beam shaper A according to the prior art with the alternately inclined sector-shaped facets B providing a circular pattern of radiating spokes or arms C from a central point D. The sector-shaped facets B on the Siemens star beam shaper are either planer or curved and produce hot spots in the ring shaped intensity distribution, as shown in FIG. 1(b). Hot spots are undesirable in laser processing applications as they can lead to local damage and poor quality of finish.

It is therefore an object of the present invention to provide an optical beam shaping element and a method of manufacturing a refractive optical beam shaping element which obviates or mitigates at least some of the disadvantages of the prior art.

According to a first aspect of the present invention there is provided an optical beam shaping element comprising a plate having a first surface with a circular pattern of sector shaped facets;
the sector shaped facets, in a circumferential direction from a centre point, being alternately inclined with respect to a plane of the plate;
a plurality of arms radiating from the centre point, each arm defining an edge between neighbouring sector shaped facets;
characterised in that:
the edges are curved with the plurality of arms being curved as they radiate outwardly in a spiral star configuration.

In this way, the prior art Siemens star beam shaper can be considered as being twisted around its centre to create a swirl or spiral star configuration, as the straight lines are now non-linear and curved. As a result, hot spots at and around the focus of a ring distribution are removed as the light otherwise concentrated in the hot spots is spread around the annular angular ring distribution.

The curved edges of the spiral may be formed in a clockwise direction. Alternatively, the curved edges of the spiral may be formed in an anti-clockwise direction.

Preferably, the optical beam shaping element is a refractive optic. Alternatively, the optical beam shaping element may be a reflective optic.

Preferably, the edges are sloped at a constant magnitude and rotated as a function of r, where r is the radial position. Preferably, each arm radiates at θ+(r/r₀)² where r is the radial position and θ an angle equal to 360 divided by the number of arms. In this way, the curve is formed for each arm.

Preferably, each edge has a radial z scaling. Thus the height of each edge varies radially from the centre point. In this way, added divergence which occurs can be recovered. Preferably, the radial z scaling gives a slope in the height. More preferably, the slope decreases as a function of r, where r is the radial position.

Preferably, each facet has a curvature. Alternatively, each facet is planar as for the Siemens star beam shaper. The curvature determines the amount of light scattered outside the ring and the ability to join the hot spots to create a ring of uniform distribution.

A particularly uniform distribution of the laser energy in an annular profile may be achieved if the even number of the facets is 18 to 72, preferably 24 to 40, in particular 36. This assumes that two facets are required with an edge to form an arm. There may then be an even or an odd number of arms.

The optical beam shaping element may comprise the first surface nested in a second surface. Preferably, the direction of curvature is reversed between the first and second surfaces. The optical beam shaping element may comprise the first surface nested in a Siemens star beam shaper surface.

Preferably, the optical beam shaping element includes a focusing lens, to provide the desired ring-shaped spot at a focal length of the focusing lens. In an embodiment the optical beam shaping element and the focusing lens are separate elements and spaced apart to provide an optical system. In an alternative embodiment the first modified surface is combined on an entrance surface of a focusing lens to provide a single optical element as the optical system.

Preferably a laser is included in the optical system with a beam of the laser being directed through the optical system to create a ring intensity profile of the laser beam focussed at the focal length of the focusing lens. The laser beam may be directed through a fiber. The optical system may also include a collimating lens between the laser and the optical beam shaping element. In this way, the invention can be used in laser welding, laser cutting, the material ablation of thin films, solar cell manufacturing, PCB laser drilling and ophthalmology.

There may be a second optical beam shaping element, wherein the first modified surface of the second optical beam shaping element is a mirror image of the first modified surface of the optical beam shaping element. Preferably, the second optical beam shaping element is arranged so that the first surfaces face each other. Alternatively, the second optical beam shaping element is arranged so that the first surfaces face away from each other. In this way, the first surfaces create opposite refraction effects. In a second optical system, there are first and second optical beam shaping elements, a collimating lens and a focusing lens. The second optical system may include a rotational mount configured to rotate the first and the second optical beam shaping elements with respect to each other around a central optical axis through the optical system. By rotating the first and the second optical beam shaping elements with respect to each other, the intensity profile of a beam of a laser being directed through the optical system can be switched between a ring intensity profile and a spot intensity profile when the arms of each optical beam shaping element are either aligned or entirely misaligned. Partial rotation can be used to generate a trident with control of power ratio between a core spot and a ring.

According to a second aspect of the present invention there is provided a method of manufacturing an optical beam shaping element, according to claim 1, comprising the steps:
(a) defining a target output far field distribution;
(b) determining the number of arms to obtain an angular distribution θ in each sector corresponding to the target output far field distribution;
(c) determining a curvature on the edge of each arm to create the first surface with the curved edges providing the spiral star configuration;
(d) machining a profile of the first surface on a substrate plate to provide the optical beam shaping element.

In this way, an improved ring-shaped output beam can be formed for laser machining.

Preferably, at step (c) the curve on the edge of each arm radiates at

$$θ + {( \frac{r}{{r}_{0}} )}^{2}$$

where r is the radial position.

Preferably, the method includes the further step of adding curvature to each facet at step (c).

The step of adding curvature may be to spread the spot in the far field so it joins up with nearest neighbour as each facet creates a spot in the far field. In this way, it is tailored to the beam input size. So, if we have 12 arms we add 30 degrees to the spot to join it.

Alternatively, the step of adding curvature may be to vary the curvature depending on the input intensity to maintain uniform illumination on the annulus.

In this way, it is tailored to the beam input size and intensity profile. For example, with a Gaussian input the curvature would have to vary more slowly towards the optic outer perimeter than in the centre:

θ(r)=θ₀+\hat{P}(r)Δθ where \hat{P}(r) is the fraction of total power enclosed by radius r.

Optionally, the step of adding curvature may be to overlap spots by much more than the angular separation. In this way aiming for insensitivity to beam size and profile (within a tolerance). The added angle to each spot is much greater than the angular separation in the far field which has an averaging effect making it insensitive to changes in input size and intensity profile.

Preferably, the height of the edge, in relation to the plane of the plate, at step (b) is scaled as a function of the radial position. In this way, radial scattering outside the annulus which occurs by adding curvature is recovered. More preferably, the height decreases in slope as a function of r, where r is the radial position.

According to a third aspect of the present invention there is provided a method of creating a ring intensity profile from a beam of a laser, comprising the steps:
(a) providing a first optical beam shaper element according to the first aspect;
(b) arranging the first optical beam shaper element in an optical system including a collimating lens and a focusing lens;
(c) locating the optical system between the laser beam and a workpiece, so as to create the ring intensity profile on the workpiece.

In this way, the optical beam shaper element can be used to provide a laser beam with a ring intensity profile on a workpiece in a laser processing application.

Preferably, the laser beam is from a fibre. The laser beam may be a multi-mode beam.

The method may include providing a second optical beam shaper element in the optical system. More preferably, the second optical beam shaper element is a mirror image of the first optical beam shaper element and their first surfaces are arranged to face each other. The method may include rotating at least one of the first and the second optical beam shaper element around a central optical axis of the optical system so that the first and the second optical beam shaper elements rotate with respect to each other. More preferably, rotation provides two configurations:
a first configuration in which the edges of the arms on the first surfaces of the first and the second optical beam shaper element are aligned and a ring intensity profile is generated at the workpiece; and
a second configuration in which the edges of the arms on the first surface of the first optical beam shaper element are aligned with valleys between the arms on the first surface of the second optical beam shaper element and a spot intensity profile is generated at the workpiece.

In this way, the optical system can provide switching between a spot intensity profile and a ring intensity profile. If the laser beam is from a fibre, the spot intensity profile may be an image of the fibre core.

Preferably, the method includes rotating the at least one of the first and the second optical beam shaper elements with respect to each other between the first and second configurations and thereby vary the power in the intensity profile. In this way an adjustable trident is formed.

In the description that follows, the drawings are not necessarily to scale. Certain features of the invention may be shown exaggerated in scale or in somewhat schematic form, and some details of conventional elements may not be shown in the interest of clarity and conciseness. It is to be fully recognized that the different features and teachings of the embodiments discussed below may be employed separately or in any suitable combination to produce the desired results.

Embodiments of the present invention will now be described, by way of example only, with reference to:

FIGS. 1(a) and 1(b) are (a) a schematic illustration and (b) a modelled intensity distribution of an output ring spot of a Siemens star beam shaper according to the prior art;

FIGS. 2(a) and 2(b) are modelled surface designs of (a) a Siemens star beam shaper according to the prior art and (b) an optical beam shaping element according to an embodiment of the present invention;

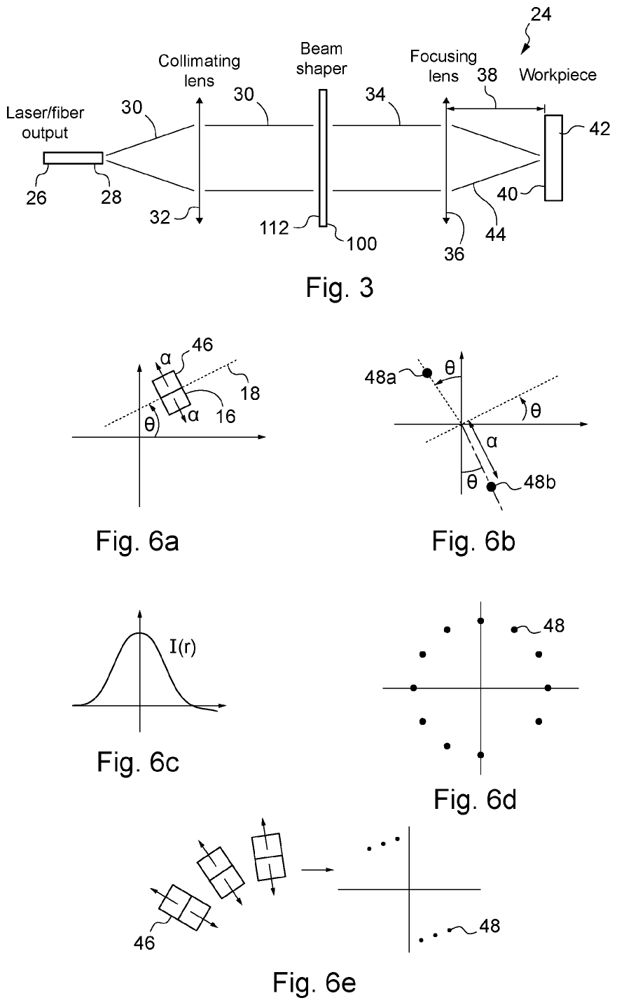

FIG. 3 is an optical system according to an embodiment of the present invention incorporating a refractive optical beam shaping element according to an embodiment of the present invention;

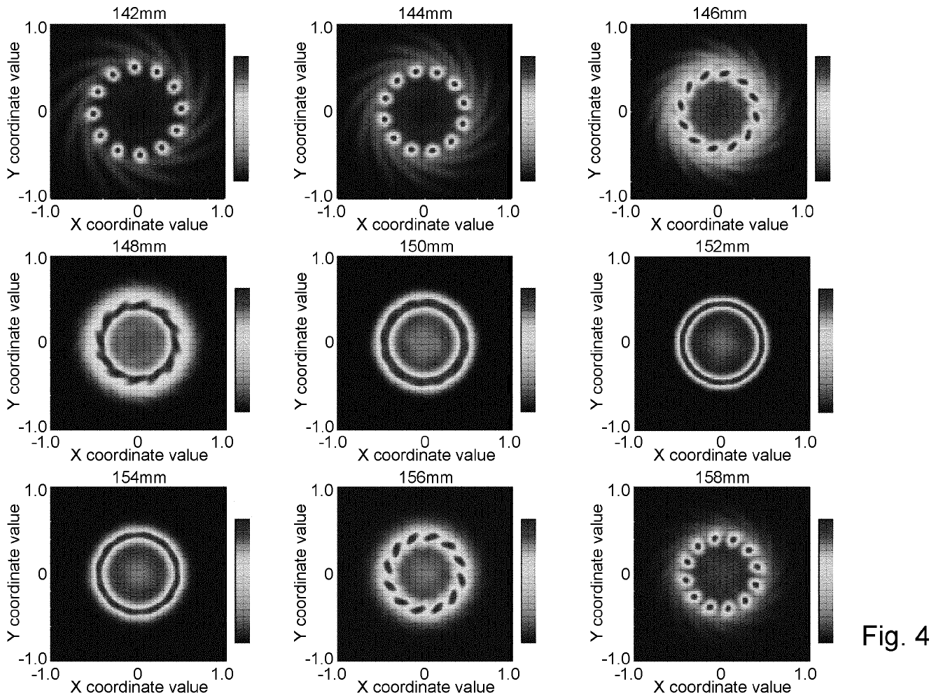

FIG. 4 is a sequence of intensity distributions of an output beam passing through the focus for an optical beam shaping element according to an embodiment of the present invention;

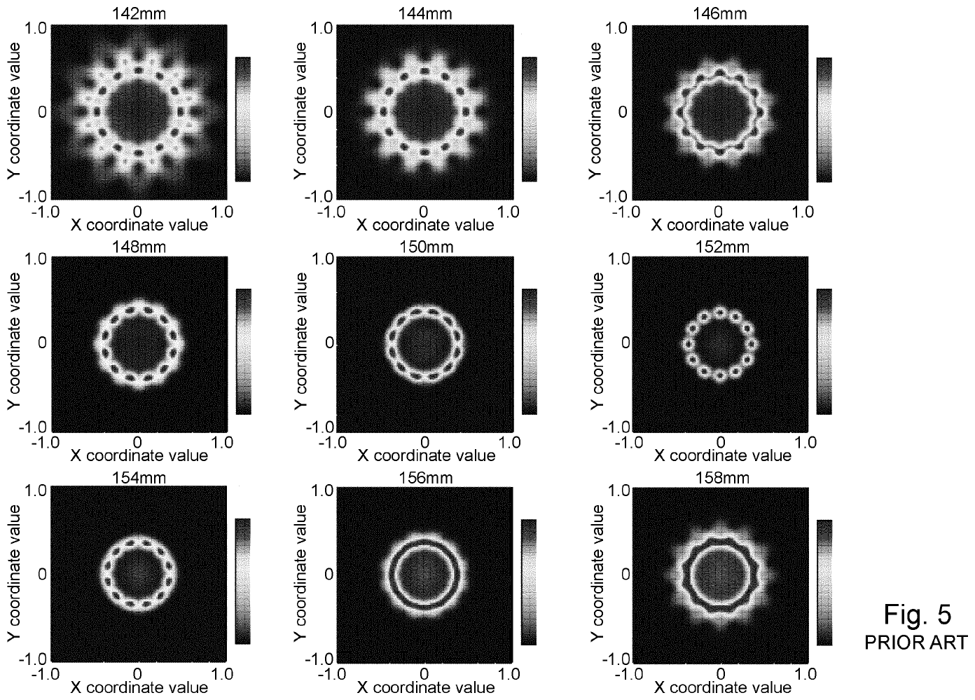

FIG. 5 is a sequence of intensity distributions of an output beam passing through the focus for a Siemens star beam shaper according to the prior art, for comparison to FIG. 4;

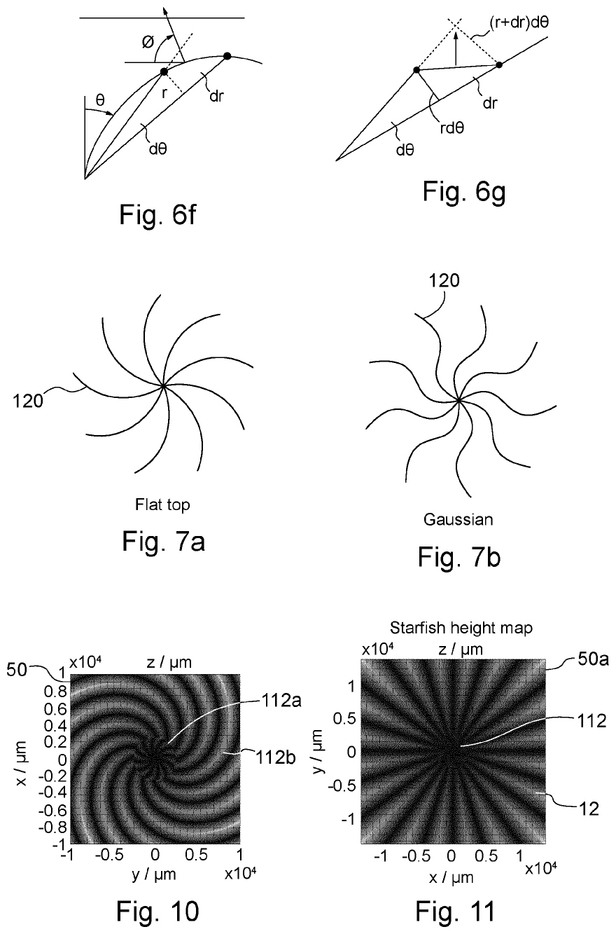

FIGS. 6(a) to 6(d) are graphs to illustrate geometry used in calculations on the demonstrate calculations on an optical beam shaping element according to an embodiment of the present invention;

FIGS. 7(a) and 7(b) are schematic illustrations of the curved edges in an optical beam shaping element according to an embodiment of the present invention for a (a) flat-top and (b) Gaussian input laser beam;

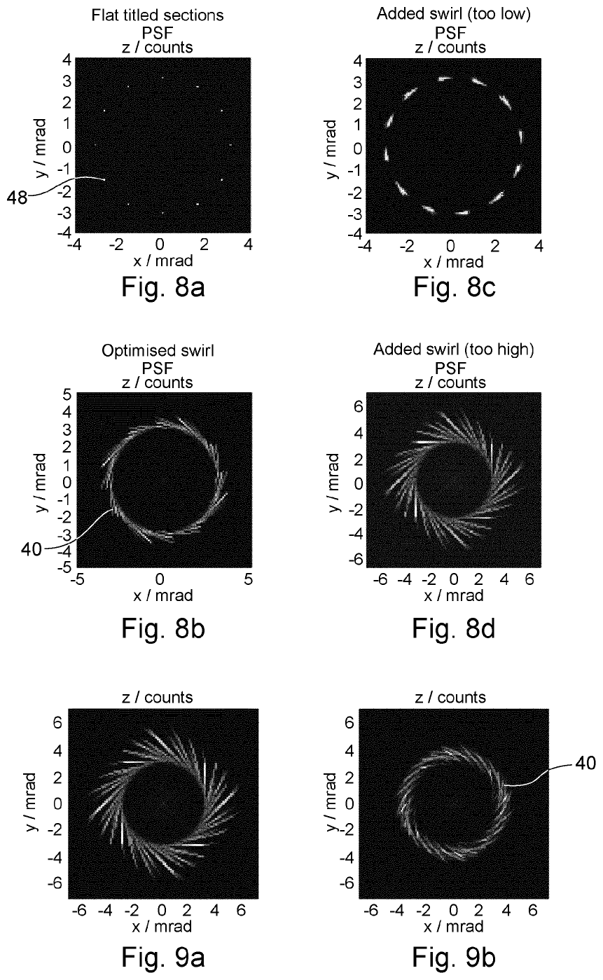

FIGS. 8(a)-(d) are modelled intensity distributions to illustrate (a) no curvature (b) optimised curvature (c) too little curvature and (d) too high curvature applied to an optical beam shaping element according to an embodiment of the present invention;

FIGS. 9(a) and 9(b) are modelled intensity distributions to illustrate (a) a widened annulus from applying a curvature and (b) a corrected annulus after applying a pre-scaling slope factor to the optical beam shaping element of FIG. 9(a);

FIG. 10 is a height map of a surface of a nested optical beam shaping element according to an embodiment of the present invention;

FIG. 11 is a height map of a surface of a nested optical beam shaping element according to a further embodiment of the present invention;

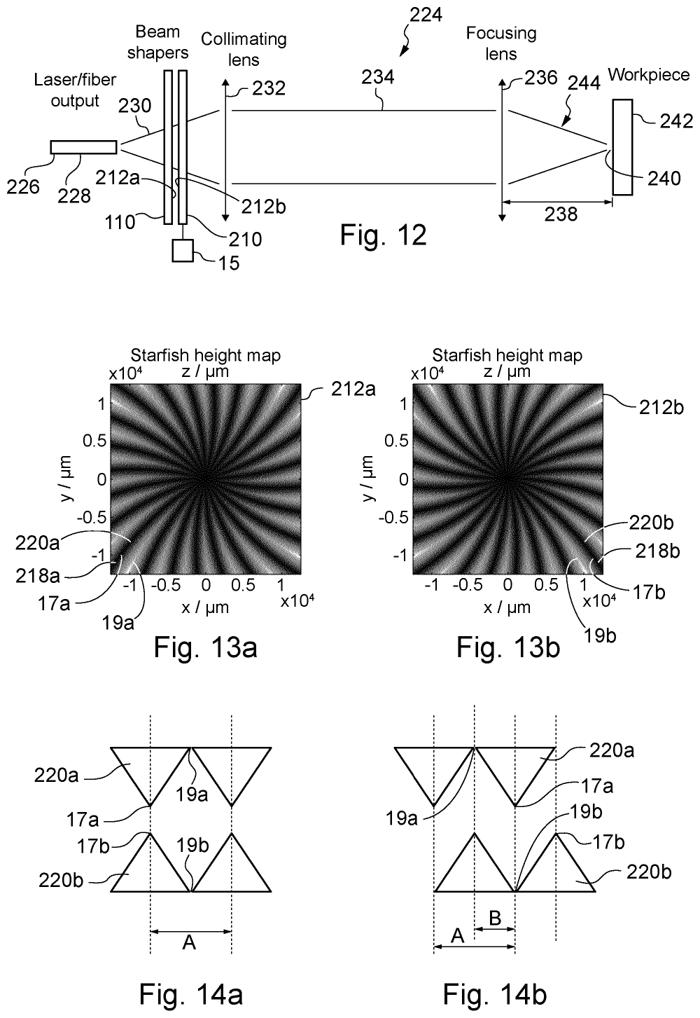

FIG. 12 is an optical system according to an embodiment of the present invention incorporating first and second optical beam shaping elements according to an embodiment of the present invention;

FIGS. 13(a) and 13(b) are modelled surface designs of (a) first and (b) second optical beam shaping elements for use in the optical system of FIG. 12;

FIGS. 14(a) and 14(b) are schematic illustrations of the arm alignment between first and second optical beam shaping elements in (a) a first configuration and (b) a second configuration in the optical system of FIG. 12; and

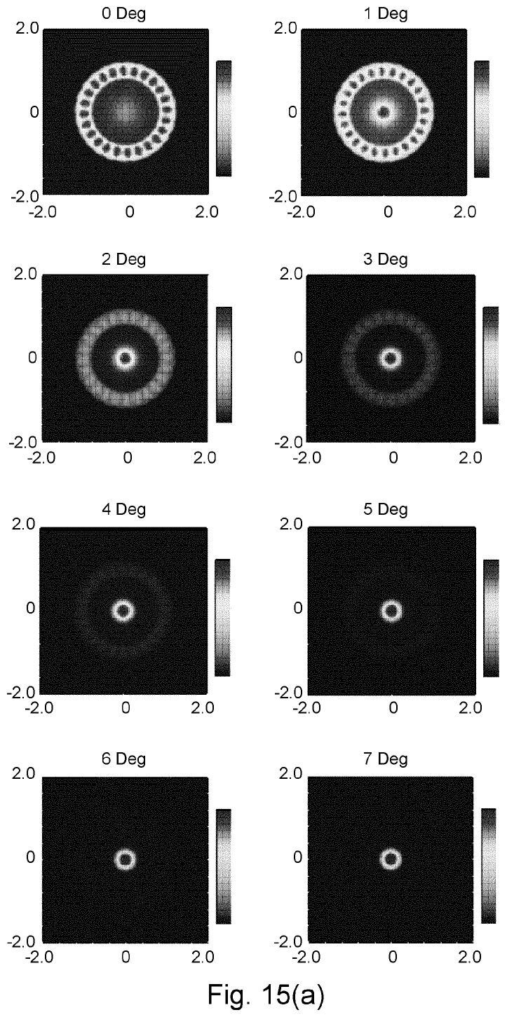

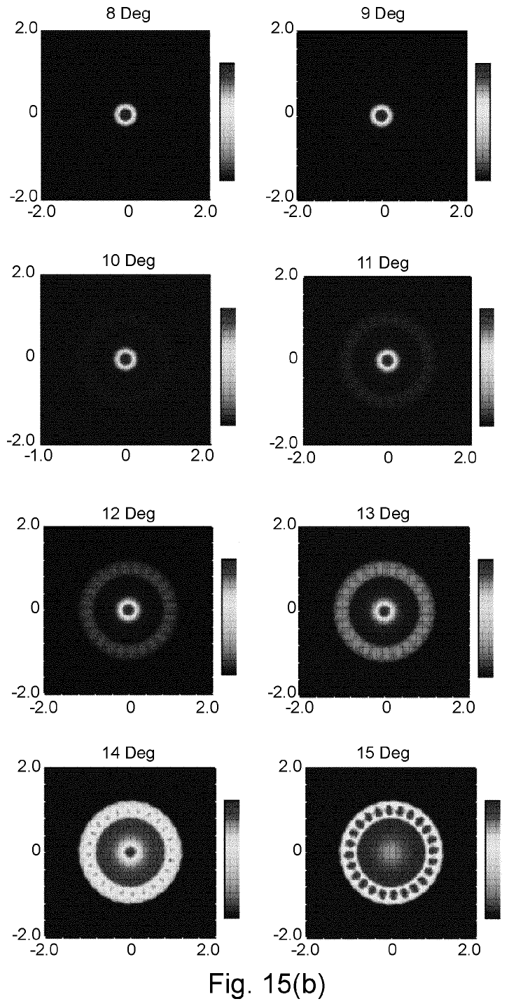

FIGS. 15(a) and 15(b) are a sequence of intensity distributions of an output beam passing through the optical system of FIG. 12 as the first and second optical beam shaping elements are rotated with respect to each other from a first configuration, through a second configuration and back to the first configuration.

Reference is initially made to FIGS. 2(a) which illustrates a surface of an optical beam shaping element, generally indicated by reference numeral 10, being a Siemens star beam shaper according to the prior art. Although shown as square, it may be any shape and is generally formed by micro-machining of a round 25 mm² square or rectangular 1 mm thick substrate plate made of fused silica, quartz glass, sapphire or ZnSe. The surface 12 is illustrated on a height map as a circular pattern of sector shaped facets 16. Edges 18 of the facets 16 are straight lines and provide spokes or arms 20 radiating from a central point 22 indicative of a Siemens star imaging target as is known in the art. At each edge 18 the surface slopes at a constant magnitude to produce ridges and valleys, with these being at a constant height across the surface. Twenty four facets 16 are shown, but there may be any even number.

Referring now to FIG. 2(b) which illustrates a surface 112 of an optical beam shaping element 100 according to an embodiment of the present invention. Like parts to those of FIG. 2(a) have been given the same reference numeral to aid clarity with the addition of 100. Surface 112 is modelled on surface 12, having the same number of facets 116, edges 118 and arms 120, however, the edges 118 are not straight lines radiating from the central point 122, but are curved. Edges 112 describe arcs which may be considered as being formed by twisting the surface 12 in a clockwise direction about the centre point 122. The facets 116 now appear as swirls and the edges 118 are spiralled. The arms 120 are no longer straight spokes 20.

In use, the optical beam shaping element 100 is placed in an optical system 24, as illustrated in FIG. 3. The optical beam shaping element 100 consists of single optical refractive surface 112. In this illustration the optical beam shaping element 100 is refractive, though it could also be constructed as a reflective optical element. A laser 26, typically multi-mode through a fibre 28, provides an input beam 30 arranged to be incident upon the surface 112 of the refractive optical beam shaping element 100. A collimator 32 provides a collimated input beam 30. The element 100 modifies the far field on the input beam into an annular or ring-shaped distribution by splitting the input beam 30 into multiple beamlets 34 and then stretching and overlapping them in the far field. The transmitted beamlets 34 are passed through a focusing lens 36 which will create the ring-shaped spot 40 at the focal length 38 of the lens 36. This position can be arranged to be incident on a workpiece 42 for application of the output beam 44. A uniform ring-like intensity distribution is obtained at the focus as well as before and after focus. In this arrangement there is a separation between the element 100 and the focusing lens 36 with each being a separate optical component in the system 24.

The refractive optical beam shaping element 100 of the present invention advantageously removes hot spots from the ring intensity distribution seen in axicons and in Siemens star beam shapers (See FIG. 1(b)), as by twisting the arms 120, the light otherwise concentrated in the hots spots, is spread around the annular angular distribution. While the axicons suffer greatly as rays in the outer part of a collimated beam input beam become radial rays, resulting in a rapidly changing through-focus behaviour. Use of a Siemens star beam shaper provides better than axicon because rays in the outer part of the collimated beam become skew rays at the focal plane as well as close to the focal plane. For the present invention, while the radial component increases it is still mainly skew, and lots of arms reduces the skew component. Reference is now made to FIG. 4 and FIG. 5 which show sequences of comparative through focus propagation intensity distributions for the refractive optical beam shaping element 100 of the present invention and for a Siemens star beam shaper, respectively. Here the focal length of the focussing lens 36 is 150 mm. The element 100, exhibits beam intensity distributions which show the influence of the twist, but with a higher degree of uniformity and smaller spot size than those of the prior art.

Considering the beam path through the optical system 24, we begin with the Siemens star beam shaper and consider an edge 18 at a spoke 20 were two facets 16 meet. This provides a roof prism 46 which deflects the beam by angle α from each facet as shown in FIG. 6(a). In the far-field, it generates two spots 48a,b at angular radius a and planar angles θ±π/2. This is illustrated in FIG. 6(b) and will occur at each spoke 20.

If the incident power density is rotationally symmetric varying as I(r), see FIG. 6(c), then enclosed power is P_{enc}=∫₀^{r}I(r)2πrdr. Total power is P₀=P_{enc}(r₀), r₀ is the full radius of the beam (100% power) and normalized enclosed power

$${\hat{P}}_{enc} ( r ) = \frac{{P}_{enc} ( r )}{{P}_{0}} .$$

Thus a twelve spoke Siemens star beam shaper 10 should generate twelve spots @30° intervals and each spot has two sources, as shown in FIG. 6(d).

In the present invention, twisting the spokes into a spiral can effectively ‘join the dots’. The roof prisms 46 now lie on a curve or spiral, see FIG. 6(e). For a continuous annulus you want uniform power per angular interval. For N spokes, you get N spots at angles

$$( {1}^{st} spot at angle θ = 0 ) \frac{2 π}{N} i \pm π ,$$

where i=0 . . . N−1.

Referring to FIGS. 6(f) and 6(g), put θₛ=2π/N and φ is the normal to the spiral arm 220.

$$d ∅ ( r ) = {θ}_{s} d \hat{P} ( r ) \\ So ∅ ( r ) = {θ}_{s} \hat{P} ( r ) \\ But ∅ = θ + r \frac{d θ}{dr} \\ So θ + r \frac{d θ}{dr} = {θ}_{s} \hat{P} ( r ) \\ \frac{d}{dr} ( r θ ) = r \frac{d θ}{dr} + θ \frac{dr}{dr} \\ ∴ \frac{d}{dr} ( r θ ) = {θ}_{s} \hat{P} ( r ) \\ d ( r θ ) = {θ}_{s} \hat{P} ( r ) dr \\ So r θ = {θ}_{s} \int \hat{P} ( r ) dr \\ θ = \frac{1}{r} {θ}_{s} \int \hat{P} ( r ) dr \\ So for uniform beam P = {r}^{2} / {r}_{0}^{2} \\ Thus giving : \\ θ = {θ}_{s} \frac{1}{3} {r}^{2} / {r}_{0}^{2}$$

As θ(r)=θ₀+\hat{P}(r)Δθ where \hat{P}(r) is the fraction of total power enclosed by radius r.

For a uniform flat-top beam

$$\hat{P} ( r ) = \frac{2 π {r}^{2}}{2 π {r}_{0}^{2}} = {( \frac{r}{{r}_{0}} )}^{2}$$

For a gaussian beam

$$\hat{P} ( r ) = 1 - {e}^{- 2 {r}^{2} / {ω}_{0}}$$

Thus curvature of the arm 120 on the modified surface 112 for a flat-top input beam gives a true spiral, as shown in FIG. 7(a). For the Gaussian it is more of a twisted spiral, see FIG. 7(b) as the spots begin and end radially, but the end of the spoke is at the angle of the start of the next spoke.

Accordingly, in a method to manufacture an optical beam shaping element 100, the starting point is a Siemens star beam shaper surface with a circular pattern of sector-shaped facets each with the same constant magnitude slope but direction perpendicular to r. The angular distribution in each section corresponds to the desired output far field distribution. An arm 20 that would radiate at θ for the prior art Siemens star beam shaper surface will now be an arm 120 radiating at

$$θ + {( \frac{r}{{r}_{0}} )}^{2}$$

where r is the radial position.

Curvature is next added to each facet 116 along the edge 118. There are a number of possible approaches for this:

Option 1: Tailor to input beam size. Each facet 116 creates a spot in the far field, see FIG. 8(a). Add enough curvature to spread the spot in the far field so it joins up with its nearest neighbour as in FIG. 8(c). In this way, for twelve arms 120 30 degrees is added to the spot 48 to join it.

Option 2: Tailor to input beam size and intensity profile. Vary the curvature depending on the input intensity to maintain uniform illumination on the annulus. For example, with a Gaussian input the curvature would have to vary more slowly towards the optic element 100 perimeter than in the centre:

θ(r)=θ₀+\hat{P}(r)Δθ where \hat{P}(r) is the fraction of total power enclosed by radius r.

Option 3: Aim for insensitivity to input beam size and intensity profile (within a tolerance). Overlap spots 48 by much more than the angular separation. So the added angle to each spot 48 is much greater than the angular separation in the far field. This has an averaging effect to be insensitive to changes in input beam size and intensity profile.

Each option will provide a different first surface 112 to the optical beam shaper element 100 of the present invention. It is noted that all options will add an element of radial scattering outside the annulus. As shown in FIG. 8(c) adding tool little curvature results in hot spots being formed as the spots 48 are not joined. If too much curvature is added, the curvature of the facets alters the surface slope to the point where light is scattered outside the ring which has the effect of widening the annulus, as seen in FIG. 8(d). The aim is to add the amount of curvature to join the hot spots but not so much to widen the annulus, this will vary depending on system set up and the relative size of the imaged fibre and target ring spot 40.

The widening of the annulus can be compensated for by scaling the z height of the initial surface 12. In the Siemens star beam shaper 10, each spoke 20 has the same height in the z axis (illustrated in the grayscale on FIG. 2(a)). Looking at the far field in polar co-ordinates the spread in the annulus is mainly in θ with a slight effect widening the annulus in r, as shown in FIG. 9(a). The widening in r can be reduced by scaling the height, and therefore reducing slope, as a function of r. In the first surface 112, the height is scaled as a function of r. In this way, the absolute slope of each arm 120 reduces as r increases. This narrows the annulus as shown in FIG. 9(b). The annulus may then be increased again by adding the curvature iteratively to reach an optimum design.

Essentially a ‘twist’ is added to a Siemens star beam shaper design by rotating the sag values as a function of r. This means the facets on the sectors are no longer planar so do not put all the light into a fixed number of angles which creates hot spots. This introduces the problem that the absolute deflection angle of the facet is no longer constant so the annulus in the far field is widened. This can be corrected by pre scaling the star sag values so the slope decreases as a function of r, this is then re-corrected with the twist.

Once the first surface 112 is defined, the optical beam shaper element 100 is constructed by a known laser optic machining process such as direct writing on a substrate to create the profile of the modified surface 112 on a plate.

The optical beam shaper element 100 of the present invention and in particular the first surface 112, lends itself to being a component in a nested optic. For example, an axicon could be shaped into the profile of the first surface 112 at its centre. Referring to FIG. 10, there is illustrated a height map of a nested optic 50, having a central circular section formed of a first surface 112a with the twists in an anti-clockwise direction, with an outer section formed of a second surface 112b, with a counter directional curvature to the first surface 112a. An alternative nested optic 50a, is illustrated in FIG. 11. Nested optic 50a has a first surface 112 within a Siemens star beam shaper surface 12. Such an optic is easier to manufacture and is more insensitive to changes in the input beam. Nesting twists improves the symmetry of the spot 40 far from focus which is an important consideration in laser metal cutting.

Reference is now made to FIG. 12 of the drawings which illustrates an optical system 224, in which there is now a first optical beam shaping element 110 and a second optical beam shaping element 210. The first optical beam shaping element 110 is created as described hereinbefore for optical beam shaping element 100 and is a beam shaper consisting of single optical refractive surface 212a with a profile of a spiralled Siemens star. The second optical beam shaping element 210 is the mirror image of the first optical beam shaping element 110. In the embodiment shown the elements 110,210 are arranged such that the machined refractive surface 212b of the second beam shaping element 210 faces the surface 212a of the first beam shaping element 110 in the optical system 224.

Alternatively, the elements 110,210 can be arranged such that the surfaces 212a,212b face away from each other.

The design flow to create the surfaces 212a,b is the same as the standard, single plate, spiral beam shaper 100 as described hereinbefore with two further steps to create the second surface 212b. As the curved facets of the optic surfaces 212a,212b need to line up, this means one must be the mirror image of the other. One way to do this is to re-design with the opposite curvature applied, a quicker way is to flip the z values in x or y so you have the mirror of the original surface. The next step is to divide the surface z values by two, this means each facet on each plate has half of the intended deflection and when both are used in combination the required spot size is generated. The height map of surfaces 212a and 212b are illustrated for an illustrative design in FIGS. 13(a) and 13(b) respectively. These show the mirror image of each other when the surfaces 212a,212b are arranged to face each other or face away from each other.

Returning to FIG. 12, the optical system 224 is arranged with a laser 226, typically multi-mode through a fibre 228, providing an input beam 230 arranged to be incident upon the surface 212a of the refractive first optical beam shaping element 110 which is facing the surface 212b of the refractive second optical beam shaping element 210. The elements 110,210 modify the input beam 230 as described hereinbefore and provide multiple beamlets 234, which are collimated by collimator 232. The collimated beamlets 234 are passed through a focusing lens 236 which will create a spot 240 at the focal length 238 of the lens 236. This position can be arranged to be incident on a workpiece 242 for application of the output beam 244.

In this arrangement, the first optical beam shaping element 110 and the second optical beam shaping element 210 can rotate relative to one another around the optical axis of the system 224. A rotational mount 15 is shown connected to element 210 for this purpose, but may be connected to either element or both elements, if desired. We consider each arm or spoke 220a,b to have an edge 218a,b which can be described as a peak 17a,b with a valley 19a,b between adjacent peaks on each surface 212a,b as shown in FIGS. 13(a) and (b). With the surfaces 212a,b facing each other it is obvious there are various stages of relative rotational alignment where the surfaces 212a,b are totally aligned either peak 17a to peak 17b or peak 17a to valley 19b. The peak 17a to peak 17b alignment maximises the phase difference through the optics and will generate a a ring intensity profile on the spot 240. The peak 17a to valley 19b alignment minimises the phase difference so at focus we see an image of the fibre core i.e. a spot intensity profile at the spot 240. Points between these two extremes are on a continuum so we can adjust the amount of power in the centre or ring forming an adjustable trident.

This alignment is illustrated in FIGS. 14(a) and 14(b). FIG. 14(a) represents peak 17a to peak 17b alignment and FIG. 14(b) represents peak 17a to valley 19b alignment. If we say the peak to peak alignment is zero degrees, so no rotational misalignment, we get a ring spot 240 in this neutral position. To move to the peak to valley position where we see a spot we need to move half a period. For example, if we have 24 arms 220a,b we need to move 7.5 degrees (each complete arm appearing as a roof prism taking up 360/24 degrees). In FIG. 14(a) the 24 arms 220a,b, are arranged peak 17a to peak 17b so point to point takes up 15 degrees in polar coordinates. Rolling the element 212b out from angle space, the distance ‘A’ is 15 degrees. In this first configuration, the phase difference is maximised and a spot 240 with a ring intensity profile is generated. Now referring to FIG. 14(b), a half period misalignment is represented. The distance ‘B’ is 7.5 degrees for the 24 arms 220a,b when the peak 17a and valley 19b are aligned. This second configuration minimises the phase difference, the two elements 110,210 cancel so an image of the fibre 228 core is generated as a spot 240 at the workpiece 242. The optical system 224 can therefore be considered to provide on/off configurations for laser processing.

Reference is now made to FIGS. 15(a) and 15(b) of the drawings which illustrate a sequence of modelled intensity distributions of a spot 240 as the elements 110,210 having 24 arms 220a,b are rotated relative to each other through 15 degrees as described above with reference to FIGS. 12 to 14. At zero and 15 degrees a ring intensity distribution is seen, between 7 and 8 degrees, a centre spot intensity distribution is created and between this first and second configurations, there is a continuum of power transfer between the centre and ring, which forms an adjustable trident so that the amount of power in the centre or the ring may be adjusted.

The principal advantage of the present invention is that it provides an optical beam shaping element giving an output beam with a uniform annular intensity distribution with reduced hot spots suitable for laser material processing.

A further advantage of the present invention is that it provides a method of manufacturing the optical beam shaping element in which a known Siemens star beam shaper surface is modified by introducing a twist.

A further advantage of an embodiment of the present invention is that it provides apparatus and method of creating a beam for laser processing which is switchable between a ring and centre intensity distribution while forming an adjustable trident to vary power between the centre or the ring.

It will be apparent to those skilled in the art that the invention can be applied in a variety of manners such as those disclosed in U.S. Ser. No. 10/444,521 wherein multiple stacked optical beam shaping elements can be used in an optical system, the optical beam shaping element may be rotated in use, and the input laser beam can be switched on and off. Also the optical system may be located on a structure so as to be moved over the work piece.

We claim:

1. An optical beam shaping element comprising a plate having a first surface with a circular pattern sector shaped facets;
the sector shaped facets, in a circumferential direction from a centre point, being alternately inclined with respect to a plane of the plate;
a plurality of arms radiating from the centre point, each arm defining an edge between neighbouring sector shaped facets;
characterised in that:
the edges are curved with the plurality of arms being curved as they radiate outwardly in a spiral star configuration.

2. An optical beam shaping element according to claim 1 wherein the optical beam shaping element is a refractive optic.

3. An optical beam shaping element according to claim 1 wherein the facets on either side of each edge are sloped at a constant magnitude and rotated as a function of r, where r is the radial position.

4. An optical beam shaping element according to claim 1 wherein each arm radiates at
$$θ + {( \frac{r}{{r}_{0}} )}^{2}$$
where r is the radial position and θ an angle equal to 360 divided by the number of arms.

5. An optical beam shaping element according to claim 1 wherein each edge has a radial z scaling.

6. An optical beam shaping element according to claim 5 wherein the radial z scaling gives a slope in the height and the slope decreases as a function of r, where r is the radial position.

7. An optical beam shaping element according to claim 1 wherein each facet has a curvature.

8. An optical beam shaping element according to claim 1 wherein the optical beam shaping element comprises the first surface nested in a second surface.

9. An optical beam shaping element according to claim 8 wherein a direction of the spiral is reversed between the first and second surfaces.

10. An optical beam shaping element according to claim 1 wherein the optical beam shaping element comprises the first surface nested in a surface with a plurality of arms having no curvature being in a Siemens star configuration.

11. An optical beam shaping element according to claim 1 wherein the optical beam shaping element includes a focusing lens, the optical beam shaping element and the focusing lens are separate elements and spaced apart to provide an optical system.

12. An optical beam shaping element according to claim 11 wherein a laser is included in the optical system with a beam of the laser being directed through the optical system to create a ring intensity profile of the laser beam focussed at the focal length of the focusing lens.

13. An optical beam shaping element according to claim 12 wherein the laser beam is directed through a fiber.

14. An optical beam shaping element according to claim 1 wherein there is a second optical beam shaping element with a first surface being a mirror image of the first surface of the optical beam shaping element.

15. A method of manufacturing an optical beam shaping element, the optical beam shaping element comprising a plate having a first surface with a circular pattern sector shaped facets; the sector shaped facets, in a circumferential direction from a centre point, being alternately inclined with respect to a plane of the plate; a plurality of arms radiating from the centre point, each arm defining an edge between neighbouring sector shaped facets; and the edges are curved with the plurality of arms being curved as they radiate outwardly in a spiral star configuration, comprising the steps:
(a) defining a target output far field distribution;
(b) determining the number of arms to obtain an angular distribution θ in each sector corresponding to the target output far field distribution;
(c) determining a curvature on the edge of each arm to create the first surface with the curved edges providing the spiral star configuration;
(d) machining a profile of the second surface on a substrate to provide the refractive optical beam shaping element.

16. The method according to claim 15 wherein at step (c) modifying the surface is by having the edge of each arm radiate at
$$θ + {( \frac{r}{{r}_{0}} )}^{2}$$
where r is the radial position.

17. The method according to claim 15 wherein the method includes the step of adding curvature to each facet at step (c) and wherein the step of adding curvature is one selected from a group consisting of: to spread the spot in the far field so it joins up with nearest neighbour as each facet creates a spot in the far field; to vary the curvature depending on the input intensity to maintain uniform illumination on the annulus; and to overlap spots by much more than the angular separation.

18. (canceled)

19. (canceled)

20. (canceled)

21. (canceled)

22. (canceled)

23. A method of creating ring intensity profile from a beam of a laser, comprising the steps:
(a) providing a first optical beam shaper element, the optical beam shaper element comprising a plate having a first surface with a circular pattern sector shaped facets; the sector shaped facets, in a circumferential direction from a centre point, being alternately inclined with respect to a plane of the plate; a plurality of arms radiating from the centre point, each arm defining an edge between neighbouring sector shaped facets; and the edges are curved with the plurality of arms being curved as they radiate outwardly in a spiral star configuration;
(b) arranging the first optical beam shaper element in an optical system including a collimating lens and a focusing lens;
(c) locating the optical system between the laser beam and a workpiece, so as to create the ring intensity profile on the workpiece.

24. A method of creating ring intensity profile from a beam of a laser according to claim 23, comprising the additional steps:
(d) providing a second optical beam shaper element, the second optical beam shaper element being a mirror image of the first optical beam shaper element; and
(e) rotating at least one of the first and the second optical beam shaper element around a central optical axis of the optical system so that the first and the second optical beam shaper elements rotate with respect to each other, to provide two operating configurations:
a first configuration in which the edges of the arms on the first surfaces of the first and the second optical beam shaper element are aligned and a ring intensity profile is generated at the workpiece; and
a second configuration in which the edges of the arms on the first surface of the first optical beam shaper element are aligned with valleys between the arms on the first surface of the second optical beam shaper element and a spot intensity profile is generated at the workpiece.

25. A method of creating ring intensity profile from a beam of a laser according to claim 24 wherein the method includes rotating the at least one of the first and the second optical beam shaper elements with respect to each other between the first and second configurations to thereby vary the power in the intensity profiles to form an adjustable trident.
